(19) United States
(12) Patent Application Publication
(10) Pub. No.: US 2026/0072567 A1
(43) Pub. Date: Mar. 12, 2026

(54) DYNAMIC AUGMENTED REALITY CONTENT DELIVERY PLATFORM

(71) Applicant: Snap, Inc., Santa Monica, CA (US)

(72) Inventor: Omer Cansizoglu, Mercer Island, WA (US)

(21) Appl. No.: 18/827,463

(22) Filed: Sep. 6, 2024

(51) Int. Cl. G06F 3/0482; G06F 3/04815; G06F 3/0484; G06T 19/00; H04N 23/62

(52) U.S. Cl. CPC G06F 3/0482; G06F 3/04815; G06F 3/0484; G06T 19/00; G06T 2200/24; H04N 23/62

(57) ABSTRACT

A system and method for creating and publishing augmented reality (AR) content using a mobile device and application. The method includes selecting a content theme, presenting associated content templates, receiving user input, and generating an AR content item. Metadata is created indicating AR content type, selected theme, and used template. The AR content item and metadata are published to a server for storage in a manner enabling retrieval and presentation via an AR device application. The system facilitates easy creation of AR content without requiring specialized AR development skills, allowing users to generate content using familiar mobile interfaces. The created content can be accessed and viewed through AR devices, providing an seamless workflow from content creation to AR presentation.

### TECHNICAL FIELD

The present disclosure relates generally to content creation and augmented reality (AR) systems. More specifically, the disclosure relates to systems and methods for generating, managing, and presenting interactive content in three-dimensional (3D) space using AR technologies, mobile applications, and AR devices.

### BACKGROUND

Over the past few decades, technological advancements have revolutionized the way we interact with digital content and our physical environment. The rapid evolution of computing power, miniaturization of components, and improvements in display technologies have given rise to a new class of devices known as augmented reality (AR) smart glasses and AR headsets.

AR smart glasses are wearable devices that overlay digital information onto the user's view of the real world. These devices typically consist of a compact computer processor, memory, various sensors, and a transparent display integrated into eyewear. The sensors, which may include cameras, accelerometers, and gyroscopes, allow the device to understand its position and orientation in three-dimensional space. This spatial awareness enables the AR system to accurately place virtual content in the user's field of view, creating the illusion that digital objects coexist with physical objects in the real world.

The potential applications for AR smart glasses are vast and diverse, ranging from entertainment and gaming to professional use cases in fields such as medicine, engineering, and education. These devices offer hands-free access to information and can provide contextual data overlaid on the user's environment, enhancing productivity and offering new ways to interact with digital content.

However, as with many emerging technologies, the widespread adoption and utility of AR smart glasses face certain challenges. One significant hurdle is the availability of compelling and diverse content specifically designed for these devices. Historically, when new types of computing platforms or devices are introduced, there is often a period where content creation lags behind hardware capabilities. This phenomenon is not unique to AR smart glasses but has been observed with the introduction of personal computers, smartphones, and virtual reality headsets.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which embodiments of the innovative subject matter set forth herein may be deployed, consistent with some examples.

FIG. 2 is a diagrammatic representation of a digital interaction system that has both client-side and server-side functionality, according to some examples.

FIG. 3 is a diagrammatic representation of a data structure as maintained in a database, consistent with some examples.

FIG. 4 is a diagrammatic representation of a message structure, according to some examples.

FIG. 5 is a user interface diagram illustrating examples of a user interface for pairing an augmented reality (AR) device, such as AR smart glasses, with a mobile computing device, and browsing experiences on a mobile device, where several experience include user-generated AR content, consistent with some examples.

FIG. 6 is a user interface diagram illustrating an example of a content creation interface for generating AR content and experiences using content templates, according to some examples.

FIG. 7 is a user interface diagram illustrating an example of an application selection interface on an AR device, consistent with some examples.

FIG. 8 is a user interface diagram illustrating an example of a content browsing interface in an AR environment, according to some examples.

FIG. 9 is a diagram illustrating an example of how AR content may be displayed in a real-world environment, where the AR content is user generated via a content template with a mobile application, consistent with some examples.

FIG. 10 is a diagram illustrating an example of a video content item displayed in an AR environment, according to some examples.

FIG. 11 is a user interface diagram illustrating an example of a settings interface for AR content, consistent with some examples.

FIG. 12 is a flowchart illustrating a method for creating and publishing AR content, according to some examples.

FIG. 13 is a flowchart illustrating a method for retrieving and displaying AR content on an AR device, consistent with some examples.

FIG. 14 is a block diagram of an example head-wearable AR device or apparatus, according to some examples.

FIG. 15 is a diagrammatic representation of a machine in the form of a computer system within which a set of instructions may be executed to cause the machine to perform any one or more of the methodologies discussed herein, according to some examples.

FIG. 16 is a block diagram showing a software architecture within which examples may be implemented, consistent with some examples.

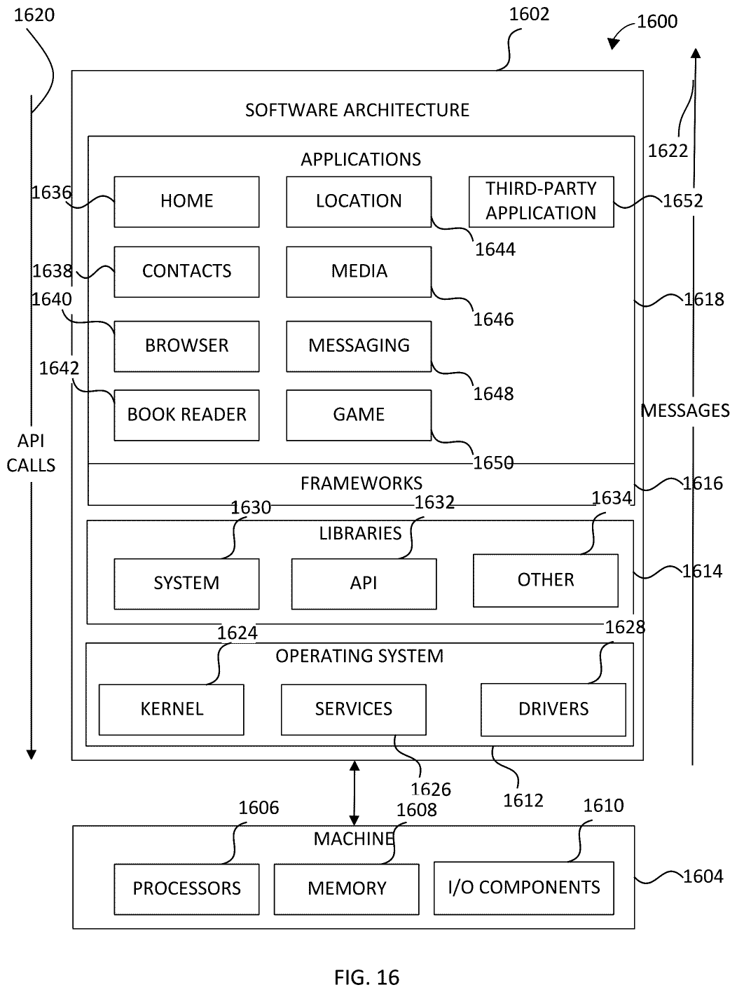

### DETAILED DESCRIPTION

The present disclosure describes systems and methods for creating, managing, and presenting interactive content in augmented reality (AR) environments, particularly for AR devices such as smart glasses, or other head-worn, AR headsets. The described techniques leverage the unique capabilities of AR and mobile technologies to streamline content creation and enhance user experiences in three-dimensional (3D) space. By employing user-friendly content templates, spatial awareness, and advanced input/output mechanisms of AR devices, the disclosed systems and methods enable users to generate and interact with AR content in ways that transcend traditional two-dimensional interfaces. The following detailed description describes various embodiments of these systems and methods, including content creation workflows, template-based authoring, spatial presentation of AR content, and context-aware content placement in real-world environments.

Current AR systems face significant technical challenges in content creation and consumption for spatial computing environments. Traditional two-dimensional interfaces and content creation tools fail to leverage the full potential of AR devices, resulting in suboptimal user experiences and limited engagement with AR content. The technical problem lies in effectively creating, representing, and interacting with digital content in three-dimensional space while maintaining usability and relevance to the user's physical environment.

Moreover, existing AR systems lack the capability to seamlessly integrate user-generated content with the physical environment, limiting the contextual relevance and immersive nature of AR experiences. The technical challenge extends to developing efficient methods for content creation, spatial mapping, object recognition, and content placement that can operate within the computational limitations of mobile devices and AR headsets while ensuring optimal and non-intrusive positioning of digital elements in the user's field of view.

Additionally, current AR platforms struggle with providing intuitive tools for non-technical users to create and share AR content. This limitation restricts the diversity and quantity of available AR experiences, hindering the widespread adoption and utility of AR technology. The technical problem involves designing a user-friendly content creation system that abstracts complex AR development processes while still allowing for rich, interactive AR experiences.

To address these technical challenges, the present disclosure proposes novel systems and methods that leverage the capabilities of both mobile devices and AR headsets. These approaches utilize computer vision algorithms, template-based content creation, and spatial awareness technologies to create immersive, three-dimensional user interfaces for AR content creation and consumption.

One technical advantage is the ability to create AR content using a mobile application with predefined templates, simplifying the content creation process for non-technical users. This is achieved through a structured input system that guides users through the creation of various types of AR experiences, such as recipes, tutorials, or interactive guides. The resulting content can then be easily shared and viewed on AR devices, bridging the gap between content creation and consumption in spatial computing environments.

Furthermore, the proposed systems incorporate advanced object recognition and spatial mapping algorithms that enable AR content to be anchored to specific real-world locations or objects. This feature allows for more intuitive and contextually relevant content placement, enhancing the overall AR experience. For example, a cooking tutorial created using the mobile application could be automatically anchored to the user's kitchen appliances when viewed through an AR device, providing step-by-step instructions in the most relevant context.

The systems also include innovative relocalization techniques that allow AR content to persist in specific locations across multiple viewing sessions. This is achieved through a combination of computer vision algorithms and spatial mapping, enabling users to place AR content in their environment and retrieve it in the same location during subsequent uses. This feature enhances the utility and immersion of AR experiences by integrating them more seamlessly with the user's physical space.

By addressing these technical challenges and leveraging the unique capabilities of both mobile devices and AR headsets, the disclosed systems and methods create a comprehensive platform for AR content creation and consumption. These solutions not only enhance the functionality and accessibility of AR technology but also pave the way for new forms of digital interaction that are more closely integrated with users'physical realities. These and other advantages will be readily apparent from the detailed description of the several figures that follows.

### Networked Computing Environment

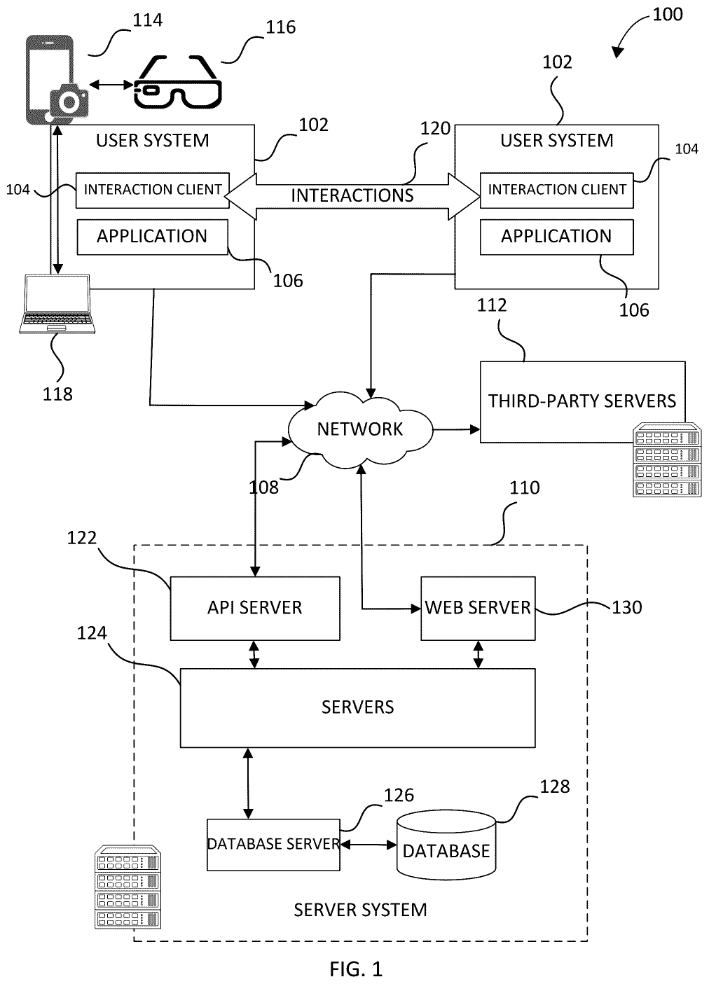

FIG. 1 illustrates an exemplary digital interaction system 100 for facilitating AR content creation and viewing experiences over a network 108. The system 100 comprises multiple user systems 102, each hosting an interaction client 104 and other applications 106. The interaction clients 104 are communicatively coupled via network 108 to other interaction clients, a server system 110, and third-party servers 112. This system enables the creation, management, and presentation of AR content, including the ability to associate content with specific real-world locations and present it to users based on their physical presence.

Each user system 102 may include multiple devices, such as a mobile device 114, a head-wearable AR device or apparatus 116, and a computer client device 118, all interconnected to exchange data and messages. The head-wearable AR apparatus 116 is equipped with sensors and cameras for capturing environmental data and detecting objects in the user's surroundings. This capability provides for determining appropriate spatial positions for displaying AR content and for implementing features such as object recognition and content relocalization.

Interaction clients 104 exchange data with each other and with the server system 110 via network 108. This data includes functions, payload data, and AR-specific information such as content templates, environmental data, and geolocation information. The system supports various content types including text, images, videos, and web links, all of which can be integrated into AR experiences.

While certain functions are described as being performed by either the interaction client 104 or the server system 110, the distribution of functionality between client and server may be adjusted based on technical considerations and device capabilities. This flexibility allows for optimal performance and user experience across different hardware configurations.

The server system 110 provides backend services to the interaction clients 104. These operations include data transmission, reception, and processing. The system handles various types of data relevant to AR experiences, such as content templates, user-generated content, geolocation information, and environmental data captured by AR devices. User interfaces of the interaction clients 104 control data exchanges within the system.

Within the server system 110, an Application Programming Interface (API) server 122 provides programmatic interfaces to servers 124, making their functions accessible to interaction clients 104, other applications 106, and third-party servers 112. The servers 124 are linked to a database server 126, which facilitates access to a database 128 storing interaction-related data. A web server 130 provides web-based interfaces to the servers 124, processing network requests over HTTP and related protocols. The servers 124 include specialized functionality for analyzing AR content, determining relevant topics or keywords, and matching them with detected objects in the user's environment to position content appropriately in 3D space.

The API server 122 manages the flow of interaction data between the servers 124, user systems 102, and third-party servers 112. It exposes a wide range of functions supported by the servers 124, including account management, content creation and sharing, media file handling, and AR-specific features such as storing content in association with real-world locations, detecting user presence in specific areas, and generating 3D visual representations of AR content.

The servers 124 host multiple systems and subsystems that support the AR content creation and viewing framework, including image processing systems for object detection and user location verification, communication systems for managing location-based content threads, and content management systems for organizing and delivering AR experiences.

### External Resources and Linked Applications

The interaction client 104 provides a user interface for accessing features of external resources, such as linked applications 106, applets, or microservices. These resources may incorporate advanced computer vision algorithms and generative language models for analyzing AR content and determining relevant topics, enhancing the overall AR experience.

External resources can be full-scale applications installed on the user's system 102 or lightweight versions hosted locally or remotely. These smaller versions, implemented using markup languages, scripting, and style sheets, offer a subset of features tailored for AR content creation and viewing.

The interaction client 104 determines whether to launch external resources independently or access them through its interface, based on whether they are locally installed or web-based. This flexibility allows for seamless integration of various tools and services into the AR content creation and viewing workflow.

The system can notify users of activity in external resources, particularly those related to AR content creation or collaborative AR experiences. Users can be invited to join active AR sessions or launch recently used resources, fostering a collaborative and engaging AR environment.

The interaction client 104 presents a list of available external resources, with context-sensitive menus displaying icons for different applications, applets, or microservices. This feature allows users to easily access tools relevant to their current AR creation or viewing task.

By integrating these external resources and linked applications, the system provides a comprehensive platform for creating, managing, and experiencing AR content. Users can leverage a wide range of tools and services to enhance their AR interactions, from content creation templates to advanced environmental analysis and location-based content delivery.

### System Architecture

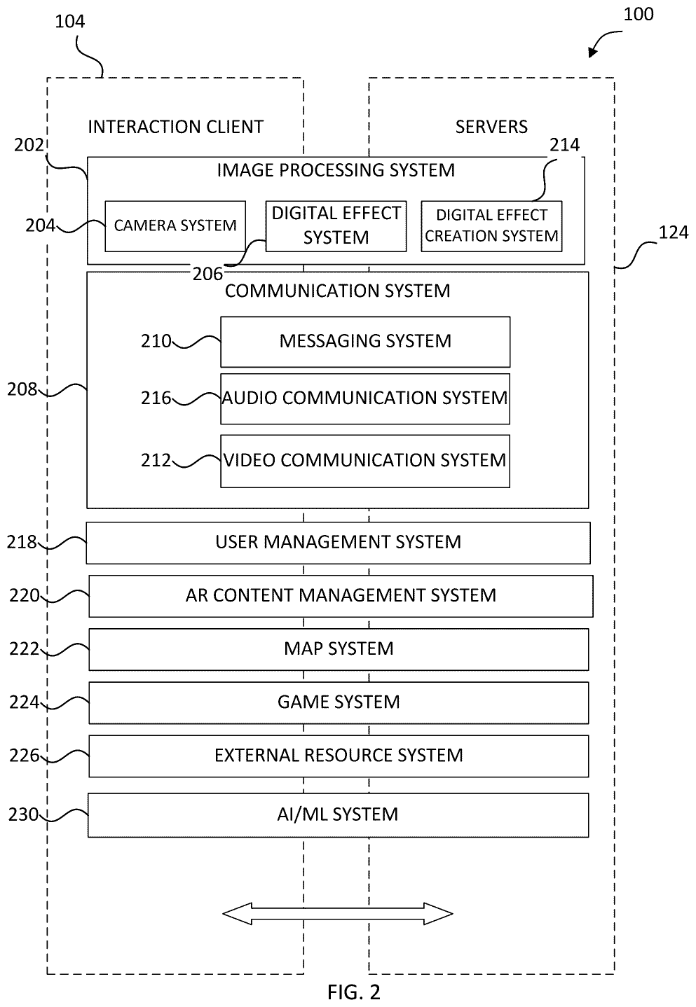

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture. Example subsystems are discussed below.

An image processing system 202 provides various functions that enable a user to capture and modify (e.g., augment, annotate or otherwise edit) media content associated with a message. The image processing system 202 includes functionality for analyzing environmental data captured by the AR device's sensors to determine appropriate spatial positions for displaying 3D visual representations of content items in the AR environment.

A camera system 204 includes control software (e.g., in a camera application) that interacts with and controls hardware camera (e.g., directly or via operating system controls) of the user system 102 to modify real-time images captured and displayed via the interaction client 104. The camera system 204 is used to capture images of the user's surroundings, which are then analyzed using computer vision algorithms to detect objects and determine the user's presence in specific real-world locations associated with content items.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 502 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Consistent with some embodiments, the digital effect system 206 is responsible for generating and rendering 3D visual representations of content items in the AR environment, taking into account the spatial positioning determined based on environmental data and detected objects.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports AR developer platforms and includes an application for content creators (e.g., artists and developers) to create and publish digital effects (e.g., AR experiences) of the interaction client 104. The digital effect creation system 214 provides a library of built-in features and tools to content creators including, for example custom shaders, tracking technology, and templates.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104. The communication system 208 manages the association of chat messages and threads with specific real-world destinations, and controls the presentation of messages to users based on their physical location. The messaging system 210 includes functionality for storing chat messages in association with specified real-world destinations, retrieving them when users enter the corresponding physical locations, and managing the temporal attributes of messages within chat threads to enable depth-based positioning in the AR environment. This system also interfaces with the spatial positioning system to determine appropriate 3D placements for chat message and content item representations based on message content, environmental context, and thread chronology.

The messaging system 210 includes additional components not shown in FIG. 2 that are specifically designed for spatial computing devices. These devices generally refer to AR headsets, smart glasses, and other wearable devices capable of overlaying digital content onto the user's view of the real world.

The additional components of the messaging system provide functionalities specific to the presentation of content in AR or 3D space, such as:
Spatial Positioning Component: Determines the appropriate 3D position for displaying chat message threads in the AR environment based on factors like message content, environmental context, and thread chronology.
Real-World Destination Manager: Associates chat messages with specific real-world locations and manages their retrieval when users enter corresponding physical spaces.
Environmental Context Analyzer: Processes data from the AR device's sensors to understand the user's surroundings and detect relevant objects for message placement.
Temporal Attribute Manager: Handles the chronological aspects of messages within a thread to enable depth-based positioning in the AR environment.

These components work together to determine the position at which content items, individual messages, or a message thread should be shown in the AR space. For example, they might analyze the content, match the content with detected objects in the environment, and position the thread near relevant real-world items or in a spatial arrangement that represents the content item, or a conversation's flow and timeline.

It's important to note that this functionality, as well as all other functionalities of the messaging system, can be implemented on the client-side (i.e., on the AR device itself), on the server-side, or through a combination of both. The specific implementation may depend on factors such as processing power requirements, need for real-time responsiveness, and data privacy considerations.

A user management system 218 is operationally responsible for the management of user data and profiles, and maintains entity information (e.g., stored in entity tables 306, entity graphs 308 and profile data 302) regarding users and relationships between users of the digital interaction system 100. The user management system 218 tracks user locations and manages the detection of users entering specific physical locations corresponding to chat thread destinations. The user management system 218 also maintains data on social connections between users, including a friends list for each user. For each friend or social connection, the system stores various relationship attributes that characterize the nature and strength of the connection. These attributes may include:
Communication frequency: A metric representing how often two users interact through the system, such as exchanging messages or sharing content.
Relationship closeness score: A numerical value indicating the overall strength of the relationship based on factors like interaction history, mutual friends, and shared interests.
Recency of interaction: A timestamp or relative measure of how recently the users have communicated or engaged with each other's content.
Shared experiences: A record of joint activities or events attended together within the system.
Content similarity: A measure of how closely the users'shared content or interests align.
Physical proximity: Data on how often users are in the same physical locations or geographic areas.

These relationship attributes can be used to determine the positioning of friends within a three-dimensional friend feed presentation. For example, friends with higher communication frequencies or relationship closeness scores may be displayed closer to the user's viewpoint, while those with lower scores may appear further away in the 3D space. Recent interactions could influence the vertical positioning, with more recent contacts appearing higher in the display. The system could also use these attributes to create a “friendship constellation” or “galaxy” visualization, where the most significant relationships are represented as larger or brighter elements in the 3D space.

By leveraging these relationship attributes, the user management system 218 enables a more intuitive and meaningful representation of a user's social network in AR environments, enhancing the overall user experience of the digital interaction system 100.

In some examples, the system includes an AR content management system 220. This system serves as the central hub for organizing, storing, and delivering AR content to users. It manages user-generated AR content items and other AR content associated with specific real-world locations, organizing them by theme, such that they can be grouped, accessed and interacted with in the AR environment. The AR content management system 220 works in close conjunction with other components of the digital interaction system to create a rich, context-aware AR experience.

The AR content management system 220 leverages the capabilities of the image processing system 202 and the camera system 204 to analyze the user's environment and determine optimal placement for AR content. It processes environmental data captured by AR devices'sensors to identify appropriate spatial positions for displaying 3D visual representations of chat messages and other AR content. This system also interfaces with the digital effect dystem 206 to generate and render these 3D visual representations, taking into account the spatial positioning determined based on environmental data and detected objects.

Working in tandem with the communication system 208, the AR content management system 220 manages the association of chat messages and threads with specific real-world destinations. It controls the presentation of messages to users based on their physical location, creating a location-aware AR experience. The system includes sophisticated functionality for storing chat messages in association with specified real-world destinations, retrieving them when users enter the corresponding physical locations, and managing the temporal attributes of messages within chat threads to enable depth-based positioning in the AR environment.

The AR content management system 220 also integrates closely with the user management system 218 to track user locations and manage the detection of users entering specific physical locations corresponding to chat thread destinations. This integration allows for personalized AR experiences based on user location and social connections.

To enhance the contextual relevance of AR content placement, the AR content management system 220 utilizes the AI/ML system 230. This system incorporates generative language models to analyze AR content items and chat message content, determine relevant topics, and match them with detected objects in the user's environment. This advanced analysis enables the AR content management system 220 to position user-generated AR content (e.g., content cards) and other AR content appropriately in 3D space, creating a more intuitive and meaningful visualization that leverages both message content and real-world context.

The AR content management system 220 also interfaces with the map system 222 to provide geographic context to AR content. This integration allows for the presentation of map-based media content and messages, enhancing the spatial awareness of the AR experience. Additionally, the system works with the external resource system 226 to incorporate content from third-party applications or services, expanding the range of AR experiences available to users.

By orchestrating these various components and functionalities, the AR content management system 220 enables users to create, share, and experience AR content in a way that is deeply integrated with their physical environment and social interactions. It transforms ordinary chat messages and digital content into immersive AR experiences, anchored to real-world locations and contextualized based on user behavior, environmental factors, and content analysis. This system represents a significant innovation in AR technology, bridging the gap between digital communication and physical space to create rich, interactive AR environments.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and AR experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands. The artificial intelligence and machine learning system 230 includes generative language models used for analyzing chat message content, determining relevant topics, and matching them with detected objects in the user's environment to position chat messages and other AR content appropriately in 3D space.

In some examples, the artificial intelligence and machine learning system 230 also interfaces with the external resource system 226 to leverage externally hosted large language models and other generative AI services. This integration enables advanced natural language processing capabilities for analyzing chat messages and determining relevant topics. The AI/ML system 230 includes a prompt processing component that receives incoming chat messages and generates tailored prompts for the external language models. These prompts typically contain the full message content as context, along with specific instructions directing the model to analyze the message and output a predetermined number of potential topics related to the message content. For example, a prompt may instruct the model to “Analyze the following message and suggest 3-5 main topics it relates to.” The external language model processes this prompt and returns a list of relevant topics. The AI/ML system 230 then uses these generated topics to inform the spatial positioning of the message or message thread within the AR environment. Messages with similar topics may be clustered together in 3D space, or messages highly relevant to objects detected in the user's real-world environment can be positioned proximally to those objects in the AR rendering. This topic-based positioning enhances the contextual relevance of message placement in the AR space, creating a more intuitive and meaningful visualization of chat threads that leverages both message content and real-world context.

### Data Architecture

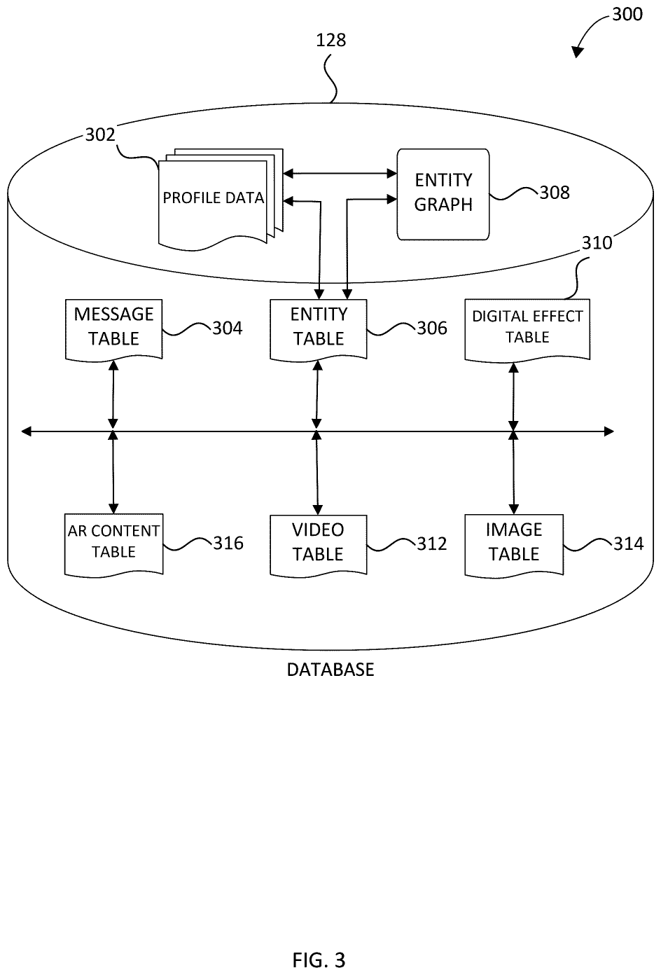

FIG. 3 illustrates a schematic diagram of data structures 300 stored in the database 128 of the server system 110. While the diagram depicts multiple tables, it's important to note that the data could be stored in other types of data structures, such as an object-oriented database.

The database 128 includes a message table 304 that stores message data, including sender data, recipient data, and payload information. This table provides for managing the communication aspects of the AR content creation and viewing system.

An entity table 306 stores entity data and is linked to an entity graph 308 and profile data 302. Entities can include individuals, organizations, objects, places, or events, each assigned a unique identifier and entity type. The entity graph 308 stores information about relationships and associations between entities, which can be social, professional, interest-based, or activity-based. These relationships play a role in the AR content management system, influencing how content is shared and presented to users.

The profile data 302 contains various types of information about entities, including usernames, contact details, settings, and avatar representations. For individual users, this data is crucial for personalizing the AR experience and managing privacy settings within the system.

The digital effect table 310 stores data related to AR content, such as overlays, filters, and other digital effects that can be applied to videos (stored in the video table 312) and images (stored in the image table 314). These digital effects are essential components of the AR content creation process, allowing users to enhance and customize their AR experiences.

One aspect of the data architecture for the AR content creation and management system is the AR content table 316. This table stores data specifically related to AR content items, including spatially-anchored chat threads, 3D visual representations of messages, and other AR experiences created by users. The AR content table 316 works in conjunction with the other tables to enable the creation, storage, and retrieval of AR content associated with specific real-world locations.

The AR content table 316, in some examples, includes fields for content identifiers, spatial coordinates, associated real-world locations, user-generated content, and metadata about the AR experience. This structure allows the system to efficiently manage and deliver AR content to users based on their physical location and interactions within the AR environment.

By integrating the AR content table 316 with the existing data structures, the system can create rich, context-aware AR experiences that leverage user profiles, social connections, and location data. This integration enables features such as spatially-anchored chat threads, location-based content delivery, and personalized AR interactions, all of which are central to the innovative AR content creation and viewing framework described in the invention.

### Data Communications Architecture

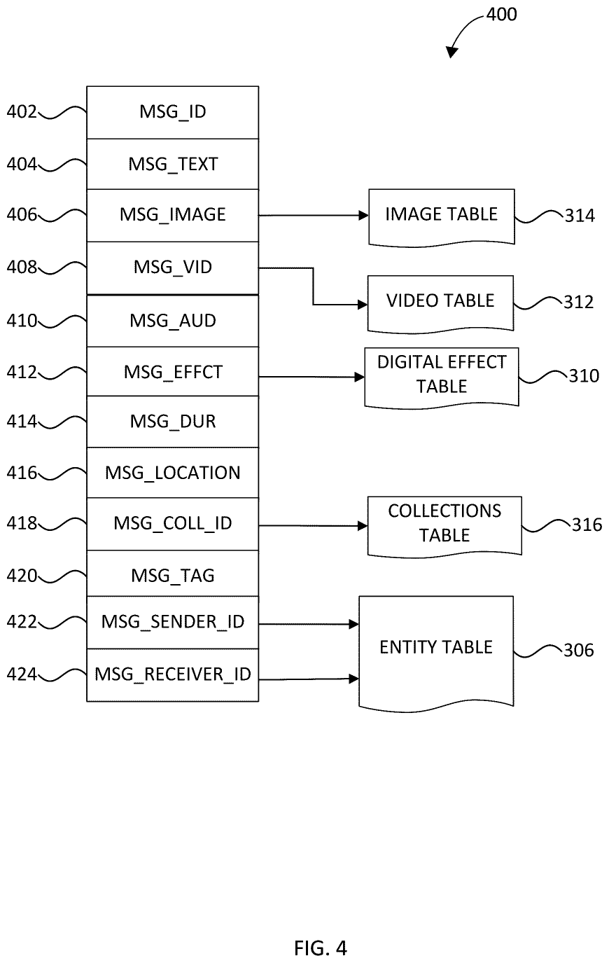

FIG. 4 illustrates a schematic diagram of the structure of a message 400 generated by an interaction client 104 for communication within the AR content creation and viewing system. The content of each message 400 populates the message table 304 stored in the database 128, accessible by the servers 124.

The message 400 includes several components tailored for AR content creation and viewing:
Message identifier 402: A unique identifier for the message.
Message text payload 404: Text content generated by the user.
Message image payload 406: Image data captured or retrieved from the user's device, stored in the image table 314.
Message video payload 408: Video data captured or retrieved from the user's device, stored in the video table 312.
Message audio payload 410: Audio data captured or retrieved from the user's device.
Message digital effect data 412: Digital effects (e.g., filters, stickers, AR overlays) applied to the message content, stored in the digital effect table 310.
Message duration parameter 414: Specifies the display duration of the message content, influencing depth-based positioning in 3D chat threads.
Message geolocation parameter 416: Geolocation data associated with the message content, crucial for location-based AR experiences.
Message collection identifier 418: Identifies content collections or “stories” with which the message is associated, used for grouping messages into spatially-anchored chat threads.
Message tag 420: Tags indicating the subject matter of the message content, used to determine appropriate spatial positioning in relation to detected objects in the user's environment.
Message sender identifier 422: Identifies the sender of the message.
Message receiver identifier 424: Identifies the intended recipient of the message.

The AR content management system leverages these parameters to create rich, context-aware experiences that seamlessly integrate with the user's physical surroundings. In some examples, a message reveal location parameter works in conjunction with the message geolocation parameter 416 to provide location-based context for AR content display. The message duration parameter 414 controls temporal aspects of message display, influencing depth-based positioning for AR content items.

By utilizing these parameters, along with geolocation data and tags, the AR system can create spatially and contextually relevant message displays that integrate seamlessly with the user's physical surroundings, enabling a more immersive and intuitive messaging experience.

This structure supports features such as spatially-anchored chat threads, location-based content delivery, and personalized AR interactions, which are central to the innovative AR content creation and viewing framework described in the invention.

The contents of various message components may be pointers to locations in tables within the database where the actual content data values are stored. For example, image values in the message image payload 406 may point to locations within the image table 314, while video values in the message video payload 408 may point to the video table 312.

This structure allows for efficient data management and retrieval within the AR content creation and viewing system.

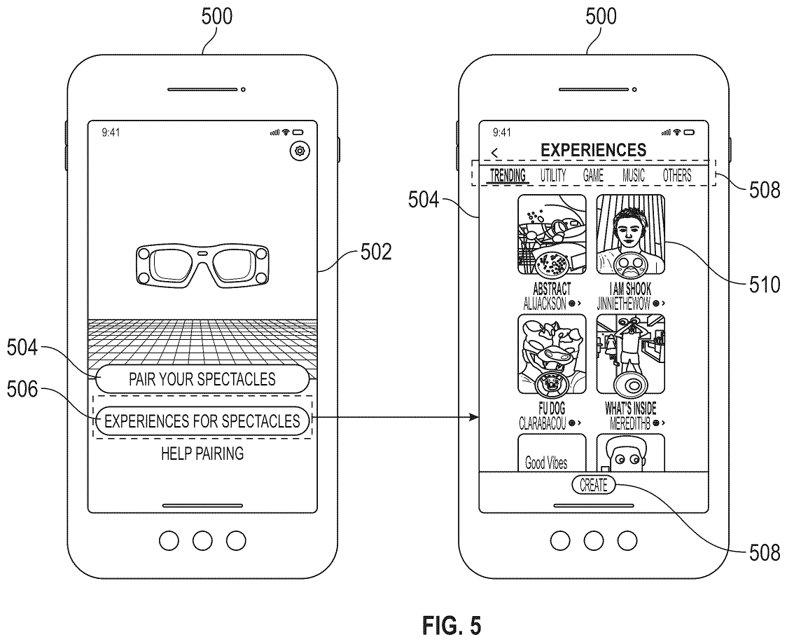

FIG. 5 illustrates a user interface flow of an AR content creation and viewing system on a mobile computing device 500, consistent with some examples. FIG. 5 showcases two different user interfaces (502 and 504) of the same mobile computing device, demonstrating the progression of user interaction within the content viewing and creation application.

The left screen displays the initial splash screen interface 502, which serves as the entry point for users. This interface features a stylized image of AR smart glasses against a vibrant background, emphasizing the device's role in the AR experience. At the bottom of this interface 502, there are two prominent buttons. The first button 504, labeled “Pair your Spectacles,” allows users to connect their AR smart glasses to the mobile application. This pairing process enables the seamless integration between the mobile device 500 and the AR glasses (not shown), allowing users to experience content in an immersive AR environment.

The second button 506, “Experiences for Spectacles,” leads users to explore available AR content. This button acts as a gateway to user-generated content that can be viewed either on the mobile device or through paired AR smart glasses, providing flexibility in how users consume AR experiences.

Upon selecting the “Experiences for Spectacles” option, the user is presented with the content selection interface, as shown on the right screen of the device 500. This interface, labeled with reference 504, provides a rich catalog of user-generated and developer-generated AR content organized into different categories. The categories are accessible through a menu bar 508 at the top of the screen, which includes options such as “Trending,” “Utility,” “Game,” “Music,” and “Others.” This categorization allows for easy navigation and discovery of diverse AR content, catering to various user interests and preferences.

The main area of the content selection interface displays a grid of individual user-generated content items, each represented by a thumbnail image and title (reference 510). These content items could include a wide range of AR experiences, such as interactive tutorials, games, or artistic creations. For example, the interface shows thumbnails for experiences like “Abstract,” “I Am Shook,” “Fu Dog,” and “What's Inside,” showcasing the variety of content available to users. By selecting a specific category from the menu bar 508, the user interface dynamically updates to display relevant generated content.

This allows users to easily browse and discover new AR experiences based on their interests or current trends. Each content item is capable of being displayed on the mobile device or via the paired AR smart glasses, or both, providing users with flexibility in how they engage with the content.

At the bottom of the content selection interface, there's a prominent “Create” button (reference 512). This button enables users to enter the content creation process, aligning with the system's goal of facilitating easy AR content creation without requiring extensive technical knowledge. By making the creation process easily accessible from the main content browsing interface, the system encourages users to not only consume but also contribute to the AR ecosystem.

Overall, FIG. 5 demonstrates the user-friendly approach of the AR content creation and viewing system. It showcases how users can seamlessly transition from pairing their AR devices to browsing a wide range of user-generated content, and finally to creating their own AR experiences. This intuitive flow is designed to lower the barrier to entry for AR content creation and consumption, fostering a rich, user-driven AR environment.

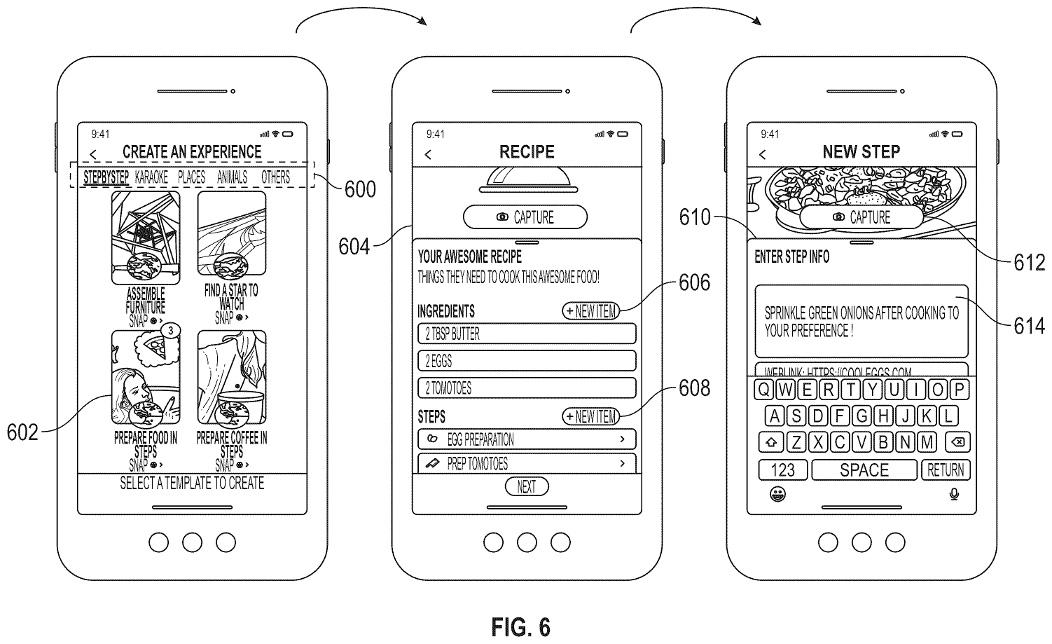

FIG. 6 illustrates a series of user interfaces on a mobile device, demonstrating the process of creating AR content within the AR content creation and viewing application and system. The figure shows three sequential views of various user interfaces of a mobile application, each representing a different stage in the content creation process. The user interfaces are logically connected by curved arrows, indicating the progression of user interaction from left to right.

The first user interface 600 displays the “Create an experience” interface. This user interface 600 presents a menu or navigation bar 602 allowing for the selection of a content theme, including options such as “StepByStep,” “Karaoke,” “Places,” “Animals,” and “Others.” Below the content them is a grid of template options with specific content creation suggestions, such as “Assemble Furniture” and “Find a star to watch.” This interface allows users to select an AR content template for their AR content, providing a structured approach to content creation without requiring extensive technical knowledge.

Upon selecting a template, the user is taken to the second user interface 604, which shows a “Recipe” interface. This user interface is dedicated to inputting the details of the chosen content type, in this case, a food recipe. The interface 604 includes a “Capture” button near the top, allowing users to add visual content to their recipe, by invoking a camera application or service to capture images and/or videos. Below this, there are sections for “Ingredients” and “Steps,” each with a “+” (606 and 608) button to add new items. This structure guides users through the content creation process, ensuring they provide all necessary information for a comprehensive AR experience.

The third user interface 610 shows the “New Step” interface, which appears when a user adds or edits a step in their recipe. This screen features another “Capture” button 612 at the top, emphasizing the importance of visual content in AR experiences. Below this, there's a text input field 614 for entering step information, with an example instruction already populated. The interface also includes a field for adding a web link, further enriching the AR content with external resources. A full keyboard is displayed at the bottom of the screen, allowing for easy text input. Throughout these example user interfaces, we can see the system's focus on simplifying AR content creation.

By providing templates, structured and grouped input fields, and easy media capture options, the application enables users to create rich AR experiences without needing to understand the underlying technical complexities. This approach aligns with the goal of making AR content creation accessible to a wide range of users, fostering a diverse and engaging AR ecosystem.

The sequential nature of the screens demonstrates the step-by-step process of content creation, guiding users from template selection to detailed content input. This intuitive flow helps ensure that the created content is comprehensive and suitable for AR presentation, potentially including spatial anchoring and integration with real-world objects as described in the AR content management system.

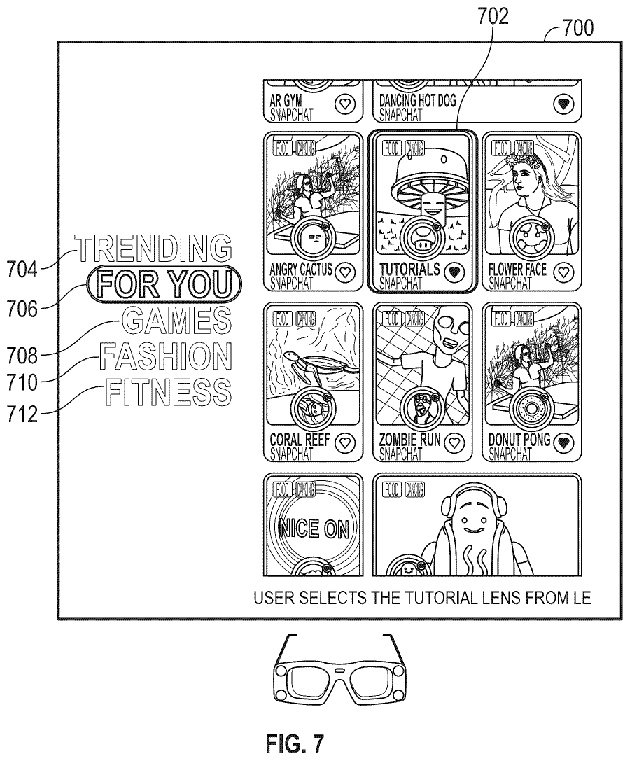

FIG. 7 illustrates a user interface 700 for an AR device, showcasing a grid of thumbnails or icons representing individual AR experiences or applications that can be executed on the device. The interface 700 is designed to allow users to easily select and launch various AR applications.

The left side of the interface displays a grouping of categories (704, 706, 708, 710, 712) that users can select to filter and view specific types of AR experiences:
“TRENDING” 704: This category would display popular AR applications based on current user engagement metrics.
“FOR YOU” 706: This section likely presents personalized recommendations tailored to the user's preferences and past interactions.
“GAMES” 708: This category showcases gaming applications available for the AR device.
“FASHION” 710: This group would present fashion-related AR experiences.
“FITNESS”712: This option would display fitness-oriented AR applications.

Selecting any of these categories would refresh the interface to show applications or experiences within the chosen group, enhancing content discovery and user experience.

The central area of the interface displays a grid of AR experiences, each represented by a thumbnail image and title. Notable examples include “AR Gym,” “Dancing Hot Dog,” “Angry Cactus,” “Flower Face,” “Coral Reef,” “Zombie Run,” and “Donut Pong.” The icon or thumbnail with reference number 702, labeled “Tutorials,” when selected, allows users to access various user-generated AR content items created using the mobile application illustrated in FIGS. 5 and 6.

The “Tutorials” app 702 serves as the central hub for the AR content viewing system, enabling users to explore and interact with user-generated AR content created by others using the mobile interface. This user interface exemplifies the system's approach to making AR content creation and consumption accessible and engaging, allowing users to easily navigate, select, and experience a variety of AR content, including user-generated experiences created through the mobile application.

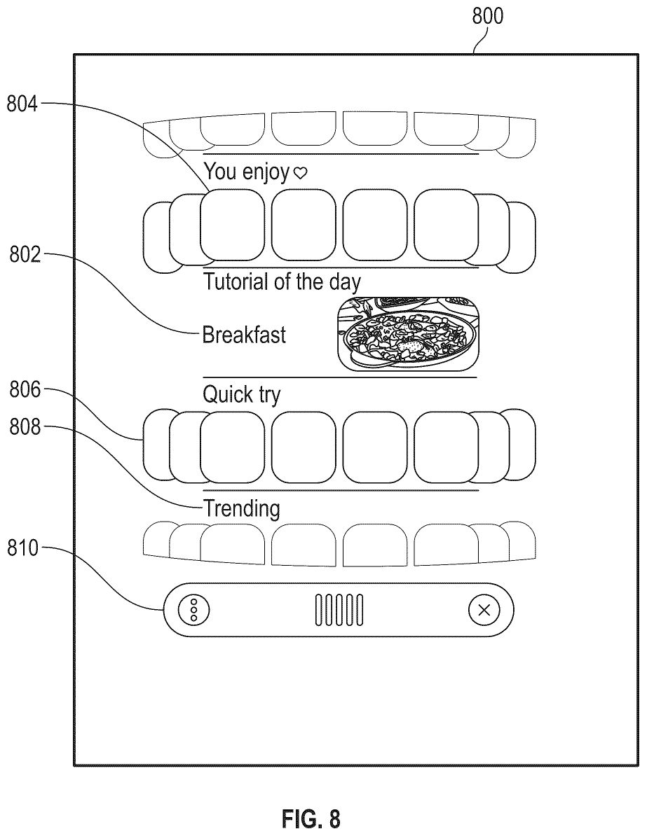

FIG. 8 illustrates the splash screen or landing page for the AR content viewing application, referred to as “Tutorials”. The interface 800 is designed to provide an intuitive and engaging user experience for accessing user-generated AR content. The interface 800 features three distinct content carousels (804, 806, 808), each representing a grouping of user-generated AR content organized by themes. These themes may be predetermined, such that the user selects them when creating the content. Alternatively, these content groupings may be based on other factors, such as user engagement.

Each content item within these carousels is associated with one of several templates corresponding to the particular theme, allowing for a structured yet diverse range of AR experiences. At the top of the interface, the first carousel 804 is labeled “You enjoy,” suggesting personalized content recommendations based on the user's preferences or past interactions. The second carousel 806, labeled “Quick try,” features easily accessible or short-form AR content for quick engagement. The third carousel 808, labeled “Trending,” showcases popular or currently viral AR experiences among users.

A highlighted content item 802, labeled “Tutorial of the day,” is prominently displayed between the first two carousels. This feature presents a specially curated AR experience, potentially refreshed daily to encourage regular user engagement. The interface is designed for intuitive interaction within the AR environment. Users can navigate through the content carousels using hand gestures, allowing for seamless scrolling and selection of AR experiences.

This gesture-based interaction aligns with the hands-free nature of AR devices, enhancing the user experience.

At the bottom of the interface, a control panel 810 provides additional functionality. This panel allows users to reposition the entire interface within their AR field of view, close the application, or access additional information and settings related to the Tutorials application. The presence of this control panel demonstrates the system's focus on user comfort and customization within the AR environment. Overall, FIG. 8 showcases an AR interface that effectively organizes and presents user-generated content created through the mobile application illustrated in previous figures. It exemplifies the system's approach to making AR content consumption accessible, engaging, and tailored to individual user preferences.

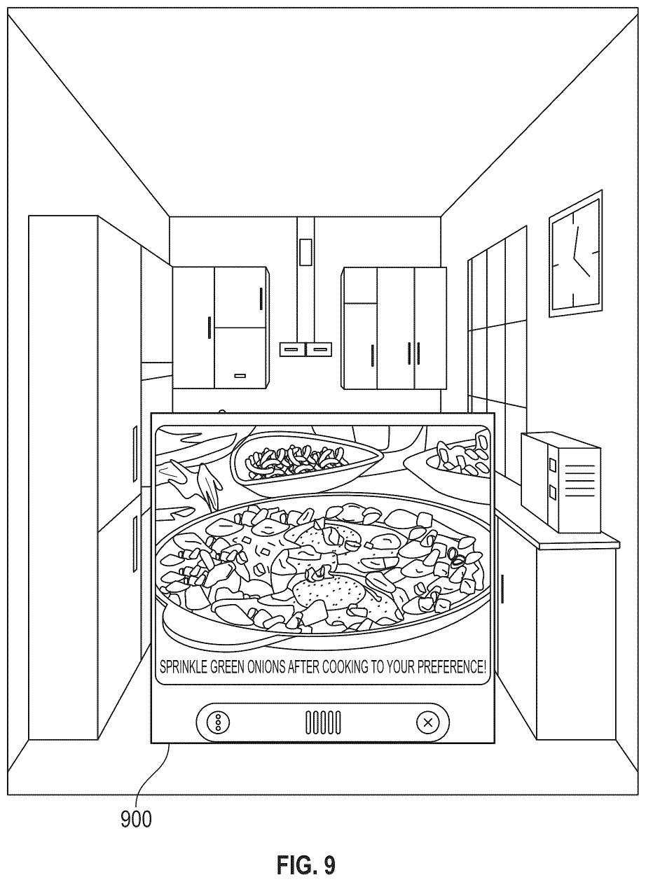

FIG. 9 illustrates an AR content card 900 displayed within a user's real-world kitchen environment. The content card 900 shows an image of a dish with eggs and tomatoes, along with the instruction “Sprinkle green onions after cooking to your preference!” This represents an individual step or component of a food recipe AR experience.

The larger rectangle surrounding the content card represents the user's real-world kitchen environment as viewed through an AR device. This visualization demonstrates how the AR system integrates digital content seamlessly into the user's physical space, enhancing the cooking experience by providing visual guidance and instructions in context.

The concept of localization and re-localization is offered for this AR experience. When a user first accesses this content item, they may have the option to “pin” or anchor it to a specific location within their kitchen. The AR system uses computer vision algorithms to detect and recognize objects in the real-world environment, such as countertops, appliances, or specific areas of the kitchen. Once the content is pinned, the AR system stores the spatial relationship between the content card and the recognized objects or features in the environment.

This allows for re-localization in subsequent uses. When the user enters the kitchen again, the AR device's vision system recognizes the environment and can determine the user's location relative to the previously pinned content. The system may then prompt or “nudge” the user to open the recipe when they enter the kitchen.

For example, it might display a notification or subtly highlight the area where the content was previously pinned. This feature ensures that relevant AR content is easily accessible when and where it's most useful, without the user having to manually search for it each time.

In relation to FIG. 9, this means that the recipe step shown in the content card 900 could be consistently displayed in the same location relative to the user's cooking area. For instance, it might appear above the stove or next to a cutting board, depending on where the user initially chose to pin it. This persistent spatial anchoring enhances the user experience by providing context-aware, hands-free access to cooking instructions, seamlessly blending the digital guidance with the physical cooking process.

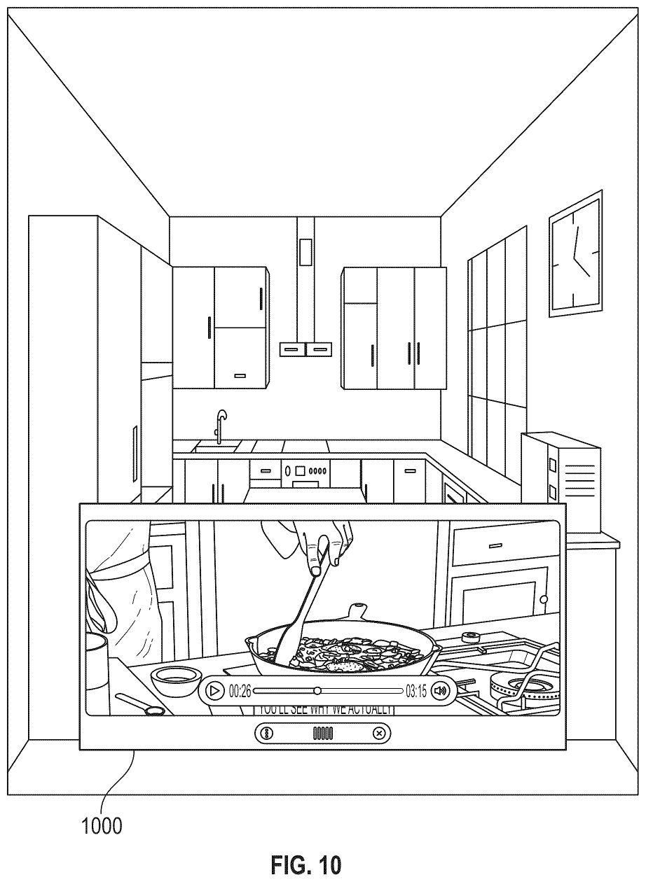

FIG. 10 illustrates an AR content card 1000 displaying a video component within the context of a food recipe experience. The content card 1000 is presented in AR or 3D space, with the implication of a kitchen environment in the background, similar to the setup described in FIG. 9.

The video component, labeled 1000 shows a cooking scene where a person is stirring a dish in a pan on a stovetop. This video was captured by a user during the content creation process using the mobile application, as described in the earlier figures. The video player interface includes standard controls such as a play/pause button, a progress bar, and audio controls, allowing the user to interact with the video content within the AR environment.

Each content card in this AR system may also include one or more links, including web or hyperlinks. When selected, these links can trigger a web browsing application to retrieve additional content that the user may have associated with the AR content item during creation. For example, in the context of this recipe, a link might lead to a website with more detailed cooking instructions, nutritional information, or related recipes.

The integration of video content and web links within the AR content card demonstrates the system's capability to provide rich, multi-media experiences that blend seamlessly with the user's real-world environment. This approach enhances the interactive and informative nature of the AR content, allowing users to access a wide range of related information and resources while engaged in the AR experience.

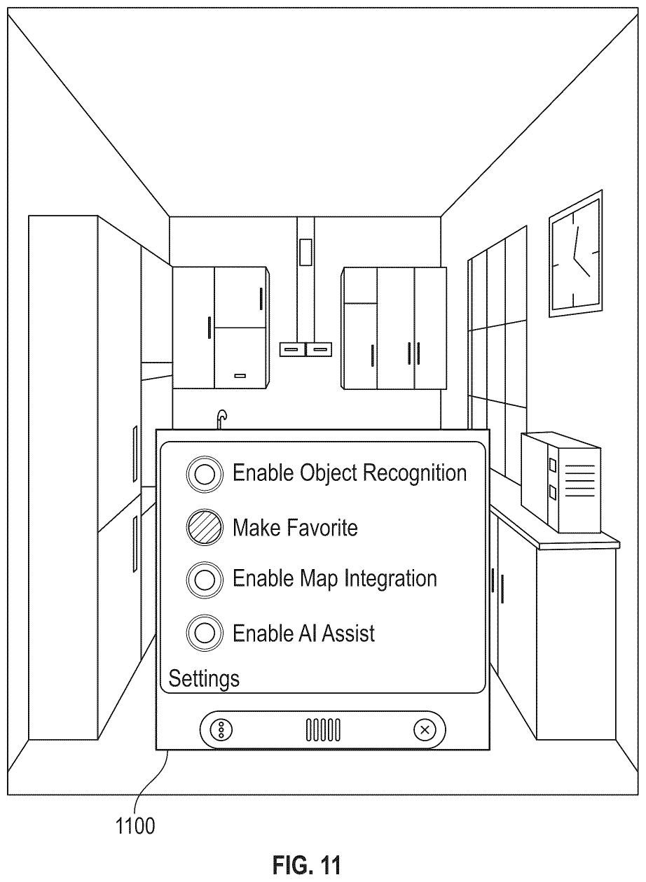

FIG. 11 illustrates a settings interface 1100 for the AR content viewing experience, providing users with a suite of customizable options to enhance their interaction with AR content. This interface presents several key features as toggle switches, allowing users to tailor their AR experience with ease and precision. The “Enable Object Recognition” setting, when activated, empowers the AR device to identify and interact with objects in the user's environment, significantly enhancing the contextual relevance of AR content. For instance, in a kitchen setting, this feature might recognize a stovetop and automatically anchor recipe instructions nearby, or identify ingredients and offer suggestions for their use.

The “Make Favorite” option allows users to bookmark particularly useful or enjoyable AR content items, creating a personalized collection for quick access. This feature not only streamlines the user experience but also informs the system's content recommendations, potentially influencing the “You enjoy” carousel on the main interface. For example, if a user frequently marks cooking-related AR experiences as favorites, the system might prioritize similar content in future recommendations.

The “Enable Map Integration” option activates the system's spatial mapping capabilities, for creating persistent and location-aware AR experiences. This feature enables the AR content to “remember” its position in the real world, allowing users to place virtual recipe cards in their kitchen and find them in the same spot days later. It also supports location-based content suggestions, such as offering city tour guides when a user enters a new urban area.

The “Enable AI Assist” option introduces an intelligent layer to the AR experience, leveraging artificial intelligence to enhance content interaction and generation. This could manifest in various ways, such as an AI assistant that can answer questions about a recipe in real-time, suggest modifications based on available ingredients, or even generate new AR content based on user preferences and environmental context.

At the bottom of the interface, a control bar provides additional functionality, including options to close the settings panel or access more advanced configurations. This comprehensive set of customizable settings underscores the system's commitment to providing a personalized, context-aware AR experience that adapts to each user's unique needs and preferences. By offering this level of customization, the AR content viewing platform not only enhances usability but also encourages deeper engagement with AR technology across a wide range of applications, from cooking and home improvement to education and entertainment.

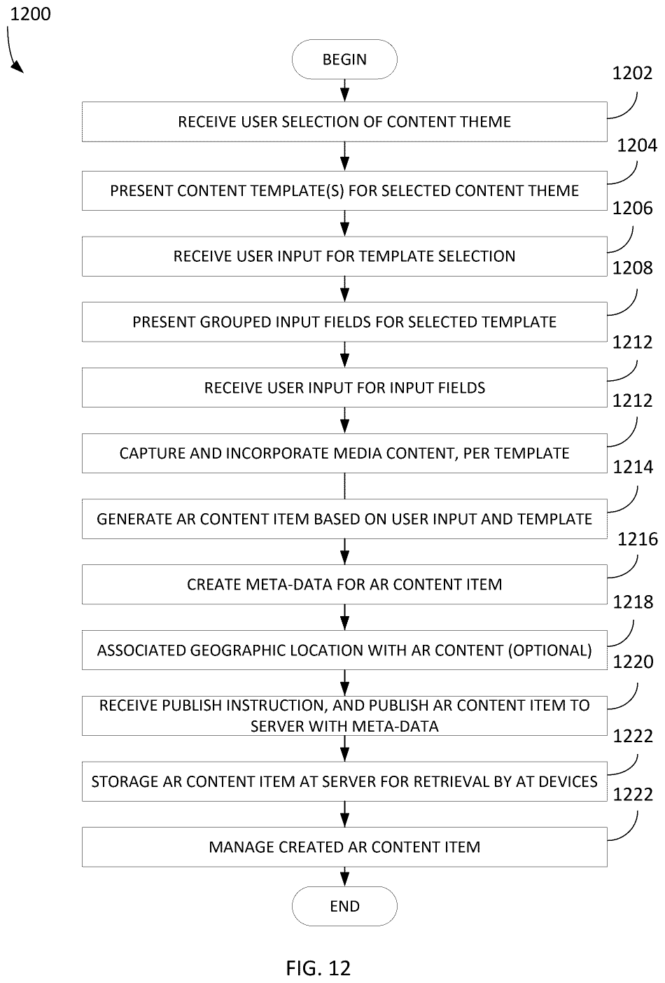

FIG. 12 illustrates a method 1200 for creating and managing AR content items using a mobile application. At step 1202, the mobile application receives a user selection of a content theme. For example, the user might select a “food recipe” theme from a list of available content themes presented in the application interface.

Step 1204 involves presenting content template(s) for the selected content theme. In the case of a food recipe theme, the application might display templates for different types of recipes, such as appetizers, main courses, or desserts.

At step 1206, the application receives user input for template selection. The user might choose a specific template that best fits their intended AR content, such as a “step-by-step cooking guide” template for their recipe.

Step 1208 presents grouped input fields for the selected template. For a recipe template, this might include separate groups for ingredients, cooking instructions, and nutritional information.

In step 1212, the application receives user input for the input fields. The user would enter details such as ingredient lists, cooking steps, and any additional information relevant to their recipe.

Step 1212 (repeated number in the figure) involves capturing and incorporating media content, per the template. This could include taking photos or videos of the cooking process or finished dish using the device's camera.

At step 1214, the application generates an AR content item based on the user input and template. This step combines all the entered information and media into a cohesive AR experience.

Step 1216 creates metadata for the AR content item. This metadata might include information about the content theme, template used, and other relevant details for categorization and retrieval. This metadata can be used in both organizing content, and selecting and presenting the content.

Step 1218, which is marked as optional, associates a geographic location with the AR content. For a recipe, this could be the user's kitchen or a favorite restaurant that inspired the dish.

At step 1220, the application receives a publish instruction and publishes the AR content item to a server with its metadata. This makes the content available for other users to access and experience.

Step 1222 involves storing the AR content item at the server for retrieval by AR devices. This ensures that the content can be accessed and displayed on compatible AR devices when requested. The final step 1222 (repeated number in the figure) is to manage the created AR content item. This could involve features like editing, deleting, or sharing the content, as well as viewing usage statistics.

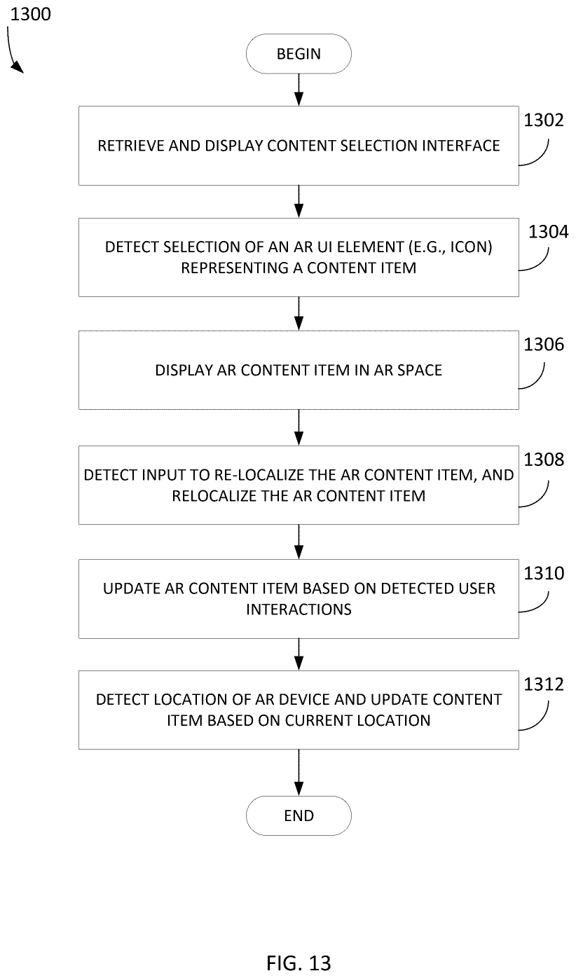

FIG. 13 illustrates a method 1300 for viewing and interacting with AR content items from an AR device perspective. At step 1302, the AR device retrieves and displays a content selection interface. This interface likely resembles the grid of thumbnails or icons representing individual AR experiences as described in the content viewing application, allowing users to browse and select from available AR content items.

Step 1304 involves detecting the selection of an AR UI element, such as an icon, representing a specific content item. For example, a user might select an icon for a cooking tutorial or a fitness routine from the displayed grid of options.

In step 1306, the selected AR content item is displayed in AR space. This could involve presenting 3D models, interactive elements, or informational cards within the user's real-world environment as viewed through the AR device.

Step 1308 detects input to re-localize the AR content item and performs the re-localization. This feature allows users to reposition or anchor the AR content within their physical space, such as placing a recipe card near the kitchen counter or exercise instructions in a workout area.

At step 1310, the AR content item is updated based on detected user interactions. This could include responding to gestures, voice commands, or gaze input to navigate through content, manipulate 3D objects, or access additional information.

The final step 1312 involves detecting the location of the AR device and updating the content item based on the current location. This feature enables location-aware experiences, such as displaying different content or adapting the AR experience as the user moves between rooms or outdoor locations.

This method outlines a comprehensive approach to AR content viewing and interaction, emphasizing user-friendly navigation, spatial awareness, and context-sensitive content delivery. It aligns with the system's goal of providing an intuitive and immersive AR experience that seamlessly integrates digital content with the user's physical environment.

### System with Head-Wearable Apparatus

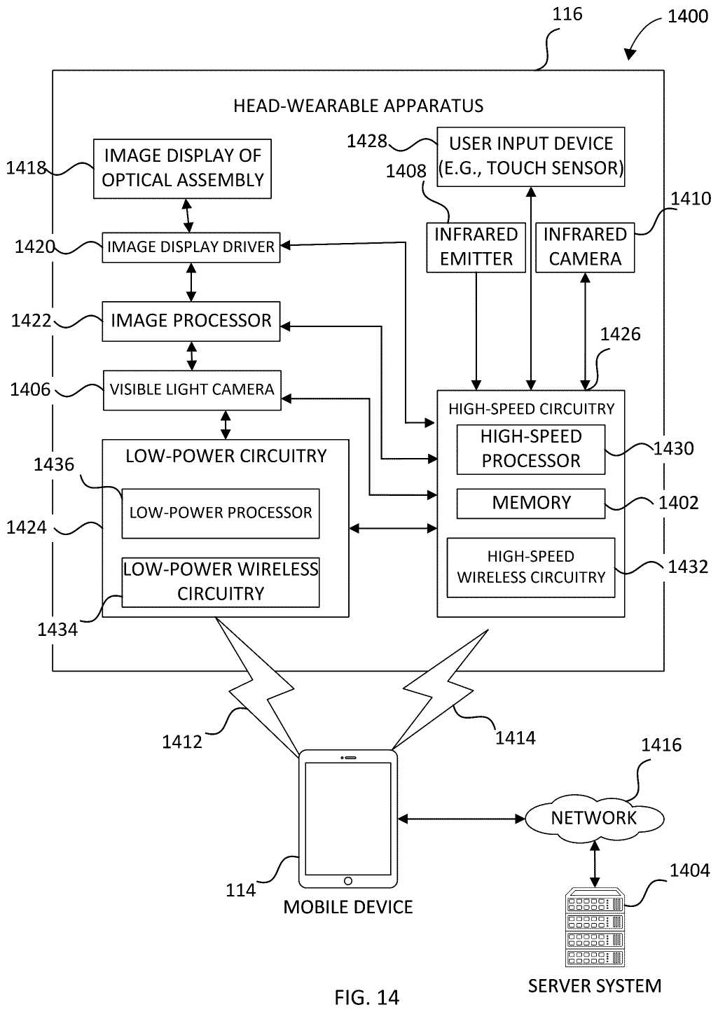

FIG. 12 illustrates a system 1400 including a head-wearable apparatus 116 with a selector input device, according to some examples. FIG. 14 is a high-level functional block diagram of an example head-wearable apparatus 116 communicatively coupled to a mobile device 114 and various server systems 1404 (e.g., the server system 110) via various networks 108.

The head-wearable apparatus 116 includes one or more cameras, each of which may be, for example, a visible light camera 1406, an infrared emitter 1408, and an infrared camera 1410.

The mobile device 114 connects with head-wearable apparatus 116 using both a low-power wireless connection 1412 and a high-speed wireless connection 1414. The mobile device 114 is also connected to the server system 1404 and the network 1416.

The head-wearable apparatus 116 further includes two image displays of the image display of optical assembly 1418. The two image displays of optical assembly 1418 include one associated with the left lateral side and one associated with the right lateral side of the head-wearable apparatus 116. The head-wearable apparatus 116 also includes an image display driver 1420, an image processor 1422, low-power circuitry 1424, and high-speed circuitry 1426. The image display of optical assembly 1418 is for presenting images and videos, including an image that can include a graphical user interface to a user of the head-wearable apparatus 116.

The image display driver 1420 commands and controls the image display of optical assembly 1418. The image display driver 1420 may deliver image data directly to the image display of optical assembly 1418 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1428 (e.g., touch sensor or push button), including an input surface on the head-wearable apparatus 116. The user input device 1428 (e.g., touch sensor or push button) is to receive from the user an input selection to manipulate the graphical user interface of the presented image.

The components shown in FIG. 14 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1406 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1402, which stores instructions to perform a subset, or all the functions described herein. The memory 1402 can also include storage device.

As shown in FIG. 14, the high-speed circuitry 1426 includes a high-speed processor 1430, a memory 1402, and high-speed wireless circuitry 1432. In some examples, the image display driver 1420 is coupled to the high-speed circuitry 1426 and operated by the high-speed processor 1430 to drive the left and right image displays of the image display of optical assembly 1418. The high-speed processor 1430 may be any processor capable of managing high-speed communications and operation of any general computing system needed for the head-wearable apparatus 116. The high-speed processor 1430 includes processing resources needed for managing high-speed data transfers on a high-speed wireless connection 1414 to a wireless local area network (WLAN) using the high-speed wireless circuitry 1432. In certain examples, the high-speed processor 1430 executes an operating system such as a LINUX operating system or other such operating system of the head-wearable apparatus 116, and the operating system is stored in the memory 1402 for execution. In addition to any other responsibilities, the high-speed processor 1430 executing a software architecture for the head-wearable apparatus 116 is used to manage data transfers with high-speed wireless circuitry 1432. In certain examples, the high-speed wireless circuitry 1432 is configured to implement Institute of Electrical and Electronic Engineers (IEEE) 802.11 communication standards, also referred to herein as WI-FI®. In some examples, other high-speed communications standards may be implemented by the high-speed wireless circuitry 1432.

The low-power wireless circuitry 1434 and the high-speed wireless circuitry 1432 of the head-wearable apparatus 116 can include short-range transceivers (e.g., Bluetooth™, Bluetooth LE, Zigbee, ANT+) and wireless wide, local, or wide area network transceivers (e.g., cellular or WI-FI®). Mobile device 114, including the transceivers communicating via the low-power wireless connection 1412 and the high-speed wireless connection 1414, may be implemented using details of the architecture of the head-wearable apparatus 116, as can other elements of the network 1416.

The memory 1402 includes any storage device capable of storing various data and applications, including, among other things, camera data generated by the left and right visible light cameras 1406, the infrared camera 1410, and the image processor 1422, as well as images generated for display by the image display driver 1420 on the image displays of the image display of optical assembly 1418. While the memory 1402 is shown as integrated with high-speed circuitry 1426, in some examples, the memory 1402 may be an independent standalone element of the head-wearable apparatus 116. In certain such examples, electrical routing lines may provide a connection through a chip that includes the high-speed processor 1430 from the image processor 1422 or the low-power processor 1436 to the memory 1402. In some examples, the high-speed processor 1430 may manage addressing of the memory 1402 such that the low-power processor 1436 will boot the high-speed processor 1430 any time that a read or write operation involving memory 1402 is needed.

As shown in FIG. 14, the low-power processor 1436 or high-speed processor 1430 of the head-wearable apparatus 116 can be coupled to the camera (visible light camera 1406, infrared emitter 1408, or infrared camera 1410), the image display driver 1420, the user input device 1428 (e.g., touch sensor or push button), and the memory 1402.

The head-wearable apparatus 116 is connected to a host computer. For example, the head-wearable apparatus 116 is paired with the mobile device 114 via the high-speed wireless connection 1414 or connected to the server system 1404 via the network 1416. The server system 1404 may be one or more computing devices as part of a service or network computing system, for example, that includes a processor, a memory, and network communication interface to communicate over the network 1416 with the mobile device 114 and the head-wearable apparatus 116.

The mobile device 114 includes a processor and a network communication interface coupled to the processor. The network communication interface allows for communication over the network 1416, low-power wireless connection 1412, or high-speed wireless connection 1414. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1420. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1404, such as the user input device 1428, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1412 and high-speed wireless connection 1414 from the mobile device 114 via the low-power wireless circuitry 1434 or high-speed wireless circuitry 1432.

### Machine Architecture

FIG. 13 is a diagrammatic representation of the machine 1500 within which instructions 1502 (e.g., software, a program, an application, an applet, an app, or other executable code) for causing the machine 1500 to perform any one or more of the methodologies discussed herein may be executed. For example, the instructions 1502 may cause the machine 1500 to execute any one or more of the methods described herein. The instructions 1502 transform the general, non-programmed machine 1500 into a particular machine 1500 programmed to carry out the described and illustrated functions in the manner described. The machine 1500 may operate as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1502, sequentially or otherwise, that specify actions to be taken by the machine 1500. Further, while a single machine 1500 is illustrated, the term “machine” shall also be taken to include a collection of machines that individually or jointly execute the instructions 1502 to perform any one or more of the methodologies discussed herein. The machine 1500, for example, may comprise the user system 102 or any one of multiple server devices forming part of the server system 110. In some examples, the machine 1500 may also comprise both client and server systems, with certain operations of a particular method or algorithm being performed on the server-side and with certain operations of the method or algorithm being performed on the client-side.

The machine 1500 may include processors 1504, memory 1506, and input/output I/O components 1508, which may be configured to communicate with each other via a bus 1510.

The memory 1506 includes a main memory 1516, a static memory 1518, and a storage unit 1520, both accessible to the processors 1504 via the bus 1510. The main memory 1506, the static memory 1518, and storage unit 1520 store the instructions 1502 embodying any one or more of the methodologies or functions described herein. The instructions 1502 may also reside, completely or partially, within the main memory 1516, within the static memory 1518, within machine-readable medium 1522 within the storage unit 1520, within at least one of the processors 1504 (e.g., within the processor's cache memory), or any suitable combination thereof, during execution thereof by the machine 1500.

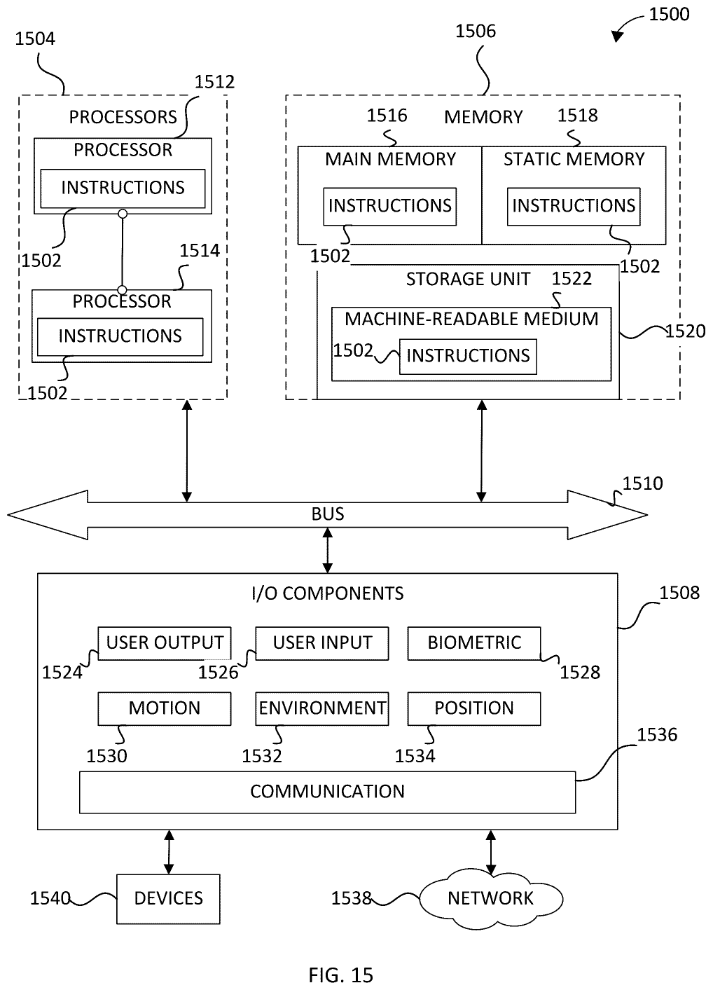

The I/O components 1508 may include a wide variety of components to receive input, provide output, produce output, transmit information, exchange information, capture measurements, and so on. The specific I/O components 1508 that are included in a particular machine will depend on the type of machine. For example, portable machines such as mobile phones may include a touch input device or other such input mechanisms, while a headless server machine will likely not include such a touch input device. It will be appreciated that the I/O components 1508 may include many other components that are not shown in FIG. 15. In various examples, the I/O components 1508 may include user output components 1524 and user input components 1526. The user output components 1524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 1530 include acceleration sensor components (e.g., accelerometer), gravitation sensor components, rotation sensor components (e.g., gyroscope).

The environmental components 1532 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360°camera for capturing 360°photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1508 further include communication components 1536 operable to couple the machine 1500 to a network 1538 or devices 1540 via respective coupling or connections. For example, the communication components 1536 may include a network interface component or another suitable device to interface with the network 1538. In further examples, the communication components 1536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1540 may be another machine or any of a wide variety of peripheral devices (e.g., a peripheral device coupled via a USB).

Moreover, the communication components 1536 may detect identifiers or include components operable to detect identifiers. For example, the communication components 1536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1536, such as location via Internet Protocol (IP) geolocation, location via Wi-Fi® signal triangulation, location via detecting an NFC beacon signal that may indicate a particular location, and so forth.

The various memories (e.g., main memory 1516, static memory 1518, and memory of the processors 1504) and storage unit 1520 may store one or more sets of instructions and data structures (e.g., software) embodying or used by any one or more of the methodologies or functions described herein. These instructions (e.g., the instructions 1502), when executed by processors 1504, cause various operations to implement the disclosed examples.

The instructions 1502 may be transmitted or received over the network 1538, using a transmission medium, via a network interface device (e.g., a network interface component included in the communication components 1536) and using any one of several well-known transfer protocols (e.g., hypertext transfer protocol (HTTP)). Similarly, the instructions 1502 may be transmitted or received using a transmission medium via a coupling (e.g., a peer-to-peer coupling) to the devices 1340.

### Software Architecture

FIG. 14 is a block diagram 1600 illustrating a software architecture 1602, which can be installed on any one or more of the devices described herein. The software architecture 1602 is supported by hardware such as a machine 1604 that includes processors 1606, memory 1608, and I/O components 1610. In this example, the software architecture 1602 can be conceptualized as a stack of layers, where each layer provides a particular functionality. The software architecture 1602 includes layers such as an operating system 1612, libraries 1614, frameworks 1616, and applications 1618. Operationally, the applications 1618 invoke API calls 1620 through the software stack and receive messages 1622 in response to the API calls 1620.

The operating system 1612 manages hardware resources and provides common services. The operating system 1612 includes, for example, a kernel 1624, services 1626, and drivers 1628. The kernel 1624 acts as an abstraction layer between the hardware and the other software layers. For example, the kernel 1624 provides memory management, processor management (e.g., scheduling), component management, networking, and security settings, among other functionalities. The services 1626 can provide other common services for the other software layers. The drivers 1628 are responsible for controlling or interfacing with the underlying hardware. For instance, the drivers 1628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1614 provide a common low-level infrastructure used by the applications 1618. The libraries 1614 can include system libraries 1630 (e.g., C standard library) that provide functions such as memory allocation functions, string manipulation functions, mathematical functions, and the like. In addition, the libraries 1614 can include API libraries 1632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and 3D in a graphic content on a display), database libraries (e.g., SQLite to provide various relational database functions), web libraries (e.g., WebKit to provide web browsing functionality), and the like. The libraries 1614 can also include a wide variety of other libraries 1634 to provide many other APIs to the applications 1618.

The frameworks 1616 provide a common high-level infrastructure that is used by the applications 1618. For example, the frameworks 1616 provide various graphical user interface (GUI) functions, high-level resource management, and high-level location services. The frameworks 1616 can provide a broad spectrum of other APIs that can be used by the applications 1618, some of which may be specific to a particular operating system or platform.

In an example, the applications 1618 may include a home application 1636, a contacts application 1638, a browser application 1640, a book reader application 1642, a location application 1644, a media application 1646, a messaging application 1648, a game application 1650, and a broad assortment of other applications such as a third-party application 1652. The applications 1618 are programs that execute functions defined in the programs. Various programming languages can be employed to create one or more of the applications 1618, structured in a variety of manners, such as object-oriented programming languages (e.g., Objective-C, Java, or C++) or procedural programming languages (e.g., C or assembly language). In a specific example, the third-party application 1652 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1652 can invoke the API calls 1620 provided by the operating system 1612 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLES

Example 1 is a device comprising: a processor; a memory coupled to the processor; and instructions stored in the memory and executable by the processor to perform operations comprising: receiving, via a content creation interface of a content creation application, a user selection of a content theme from a plurality of available content themes; presenting at least one content template associated with the selected content theme; receiving user input corresponding to the at least one content template; generating an augmented reality (AR) content item based on the user input and the at least one content template; creating metadata associated with the AR content item, wherein the metadata indicates (i) that the content item is AR content, (ii) the selected content theme, and (iii) the at least one content template used to generate the AR content item; receiving a user command to publish the AR content item; in response to receiving the user command to publish, communicating the AR content item and the associated metadata to a server for storage; wherein the AR content item and the associated metadata are stored on the server in a manner that enables retrieval and presentation of the AR content item via an application executing on an AR device.

In Example 2, the subject matter of Example 1 includes, wherein the instructions are further executable by the processor to perform additional operations comprising: presenting a content creation interface comprising a plurality of input field groups, each group associated with a different aspect of the AR content item; for each input field group: displaying a set of input fields corresponding to the group; receiving user input for each of the displayed input fields; and presenting a user-selectable option to add a custom field to the group; in response to user selection of the option to add a custom field: displaying an interface for defining a new custom input field; receiving user input defining the new custom input field; adding the new custom input field to the current input field group; after receiving input for all groups, generate the AR content item by populating the at least one content template with the user input received for each of the input fields in all groups.

In Example 3, the subject matter of Examples 1-2 includes, wherein the instructions are further executable by the processor to perform further operations comprising: presenting a media capture interface within the content creation interface; in response to user selection of the media capture interface, invoking a camera application on the device; receiving user-captured media content via the camera application, wherein the user-captured media content comprises one or more photos or videos; and incorporating the user-captured media content into the AR content item.

In Example 4, the subject matter of Example 3 includes, wherein: the selected content theme is a food recipe theme; a first input field group comprises fields for inputting ingredient information; a second input field group comprises fields for inputting cooking instruction information; the instructions are further executable by the processor to: present a media capture interface within the content creation interface for capturing images or videos of food preparation steps; receiving user-captured media content via the media capture interface; and incorporate the user-captured media content into the AR content item as visual aids for the cooking instructions.

In Example 5, the subject matter of Examples 1-4 includes, wherein the instructions are further executable by the processor to perform operations comprising: presenting a content management interface displaying a list of user-created AR content items; receiving a user selection of an AR content item from the list; displaying options to edit, delete, or share the selected AR content item; and in response to receiving a user command to share the selected AR content item, generate a deep link associated with the AR content item, wherein the deep link is configured to launch an AR viewing application on an AR device and retrieve the associated AR content item from the server.

In Example 6, the subject matter of Examples 1-5 includes, wherein the AR content item comprises: 3D spatial information defining a position and orientation of the AR content item within a real-world environment; interactive elements that respond to user gestures or movements in the real-world environment; depth information enabling the AR content item to interact with real-world objects, including occlusion and collision detection; adaptive rendering instructions that adjust the appearance of the AR content item based on real-world lighting conditions; and anchor points that allow the AR content item to be persistently placed in specific locations within the real-world environment, enabling relocalization of the AR content item across multiple viewing sessions.

In Example 7, the subject matter of Examples 1-6 includes, wherein the instructions are further executable by the processor to: present a location pinning interface within the content creation interface; receive user input specifying a geographic location or area associated with the AR content item; associate the specified geographic location or area with the AR content item as part of the metadata; wherein the metadata enables the AR content item to be: automatically suggested to users of AR devices when they are within a predetermined proximity to the specified geographic location or area; and anchored to specific real-world coordinates or landmarks within the specified geographic location or area when viewed through an AR device.

Example 8 is a method comprising: receiving, via a content creation interface of a content creation application, a user selection of a content theme from a plurality of available content themes; presenting at least one content template associated with the selected content theme; receiving user input corresponding to the at least one content template; generating an AR content item based on the user input and the at least one content template; creating metadata associated with the AR content item, wherein the metadata indicates (i) that the content item is AR content, (ii) the selected content theme, and (iii) the at least one content template used to generate the AR content item; receiving a user command to publish the AR content item; in response to receiving the user command to publish, communicating the AR content item and the associated metadata to a server for storage; wherein the AR content item and the associated metadata are stored on the server in a manner that enables retrieval and presentation of the AR content item via an application executing on an AR device.

In Example 9, the subject matter of Example 8 includes, presenting a content creation interface comprising a plurality of input field groups, each group associated with a different aspect of the AR content item; for each input field group: displaying a set of input fields corresponding to the group; receiving user input for each of the displayed input fields; and presenting a user-selectable option to add a custom field to the group; in response to user selection of the option to add a custom field: displaying an interface for defining a new custom input field; receiving user input defining the new custom input field; adding the new custom input field to the current input field group; after receiving input for all groups, generating the AR content item by populating the at least one content template with the user input received for each of the input fields in all groups.

In Example 10, the subject matter of Examples 8-9 includes, presenting a media capture interface within the content creation interface; in response to user selection of the media capture interface, invoking a camera application; receiving user-captured media content via the camera application, wherein the user-captured media content comprises one or more photos or videos; and incorporating the user-captured media content into the AR content item.

In Example 11, the subject matter of Example 10 includes, wherein: the selected content theme is a food recipe theme; a first input field group comprises fields for inputting ingredient information; a second input field group comprises fields for inputting cooking instruction information; the method further comprises: presenting a media capture interface within the content creation interface for capturing images or videos of food preparation steps; receiving user-captured media content via the media capture interface; and incorporating the user-captured media content into the AR content item as visual aids for the cooking instructions.

In Example 12, the subject matter of Examples 8-11 includes, presenting a content management interface displaying a list of user-created AR content items; receiving a user selection of an AR content item from the list; displaying options to edit, delete, or share the selected AR content item; and in response to receiving a user command to share the selected AR content item, generating a deep link associated with the AR content item, wherein the deep link is configured to launch an AR viewing application on an AR device and retrieve the associated AR content item from the server.

In Example 13, the subject matter of Examples 8-12 includes, wherein the AR content item comprises: 3D spatial information defining a position and orientation of the AR content item within a real-world environment; interactive elements that respond to user gestures or movements in the real-world environment; depth information enabling the AR content item to interact with real-world objects, including occlusion and collision detection; adaptive rendering instructions that adjust the appearance of the AR content item based on real-world lighting conditions; and anchor points that allow the AR content item to be persistently placed in specific locations within the real-world environment, enabling relocalization of the AR content item across multiple viewing sessions.

In Example 14, the subject matter of Examples 8-13 includes, presenting a location pinning interface within the content creation interface; receiving user input specifying a geographic location or area associated with the AR content item; associating the specified geographic location or area with the AR content item as part of the metadata; wherein the metadata enables the AR content item to be: automatically suggested to users of AR devices when they are within a predetermined proximity to the specified geographic location or area; and anchored to specific real-world coordinates or landmarks within the specified geographic location or area when viewed through an AR device.

Example 15 is a device comprising: means for receiving, via a content creation interface of a content creation application, a user selection of a content theme from a plurality of available content themes; means for presenting at least one content template associated with the selected content theme; means for receiving user input corresponding to the at least one content template; means for generating an AR content item based on the user input and the at least one content template; means for creating metadata associated with the AR content item, wherein the metadata indicates (i) that the content item is AR content, (ii) the selected content theme, and (iii) the at least one content template used to generate the AR content item; means for receiving a user command to publish the AR content item; means for communicating, in response to receiving the user command to publish, the AR content item and the associated metadata to a server for storage; wherein the AR content item and the associated metadata are stored on the server in a manner that enables retrieval and presentation of the AR content item via an application executing on an AR device.

In Example 16, the subject matter of Example 15 includes, means for presenting a content creation interface comprising a plurality of input field groups, each group associated with a different aspect of the AR content item; for each input field group: means for displaying a set of input fields corresponding to the group; means for receiving user input for each of the displayed input fields; and means for presenting a user-selectable option to add a custom field to the group; means for displaying, in response to user selection of the option to add a custom field, an interface for defining a new custom input field; means for receiving user input defining the new custom input field; means for adding the new custom input field to the current input field group; means for generating, after receiving input for all groups, the AR content item by populating the at least one content template with the user input received for each of the input fields in all groups.

In Example 17, the subject matter of Examples 15-16 includes, means for presenting a media capture interface within the content creation interface; means for invoking, in response to user selection of the media capture interface, a camera application on the device; means for receiving user-captured media content via the camera application, wherein the user-captured media content comprises one or more photos or videos; and means for incorporating the user-captured media content into the AR content item.

In Example 18, the subject matter of Example 17 includes, wherein: the selected content theme is a food recipe theme; a first input field group comprises fields for inputting ingredient information; a second input field group comprises fields for inputting cooking instruction information; the device further comprising: means for presenting a media capture interface within the content creation interface for capturing images or videos of food preparation steps; means for receiving user-captured media content via the media capture interface; and means for incorporating the user-captured media content into the AR content item as visual aids for the cooking instructions.

In Example 19, the subject matter of Examples 15-18 includes, means for presenting a content management interface displaying a list of user-created AR content items; means for receiving a user selection of an AR content item from the list; means for displaying options to edit, delete, or share the selected AR content item; and means for generating, in response to receiving a user command to share the selected AR content item, a deep link associated with the AR content item, wherein the deep link is configured to launch an AR viewing application on an AR device and retrieve the associated AR content item from the server.

In Example 20, the subject matter of Examples 15-19 includes, wherein the AR content item comprises: means for defining 3D spatial information of a position and orientation of the AR content item within a real-world environment; means for providing interactive elements that respond to user gestures or movements in the real-world environment; means for enabling depth information for the AR content item to interact with real-world objects, including occlusion and collision detection; means for adjusting the appearance of the AR content item based on real-world lighting conditions; and means for allowing the AR content item to be persistently placed in specific locations within the real-world environment, enabling relocalization of the AR content item across multiple viewing sessions.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Terms

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions.

Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations.

Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, network attached storage (NAS), storage area networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium. ” “Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A device comprising:
a processor;
a memory coupled to the processor; and
instructions stored in the memory and executable by the processor to perform operations comprising:
receiving, via a content creation interface of a content creation application, a user selection of a content theme from a plurality of available content themes;
presenting at least one content template associated with the selected content theme;
receiving user input corresponding to the at least one content template;
generating an augmented reality (AR) content item based on the user input and the at least one content template;
creating metadata associated with the AR content item, wherein the metadata indicates (i) that the content item is AR content, (ii) the selected content theme, and (iii) the at least one content template used to generate the AR content item;
receiving a user command to publish the AR content item;
in response to receiving the user command to publish, communicating the AR content item and the associated metadata to a server for storage;
wherein the AR content item and the associated metadata are stored on the server in a manner that enables retrieval and presentation of the AR content item via an application executing on an AR device.

2. The device of claim 1, wherein the instructions are further executable by the processor to perform additional operations comprising:
presenting a content creation interface comprising a plurality of input field groups, each group associated with a different aspect of the AR content item;
for each input field group:
displaying a set of input fields corresponding to the group;
receiving user input for each of the displayed input fields; and
presenting a user-selectable option to add a custom field to the group;
in response to user selection of the option to add a custom field:
displaying an interface for defining a new custom input field;
receiving user input defining the new custom input field;
adding the new custom input field to the current input field group;
after receiving input for all groups, generate the AR content item by populating the at least one content template with the user input received for each of the input fields in all groups.

3. The device of claim 1, wherein the instructions are further executable by the processor to perform further operations comprising:
presenting a media capture interface within the content creation interface;
in response to user selection of the media capture interface, invoking a camera application on the device;
receiving user-captured media content via the camera application, wherein the user-captured media content comprises one or more photos or videos; and
incorporating the user-captured media content into the AR content item.

4. The device of claim 3, wherein:
the selected content theme is a food recipe theme;
a first input field group comprises fields for inputting ingredient information;
a second input field group comprises fields for inputting cooking instruction information;
the instructions are further executable by the processor to:
present a media capture interface within the content creation interface for capturing images or videos of food preparation steps;
receiving user-captured media content via the media capture interface; and
incorporate the user-captured media content into the AR content item as visual aids for the cooking instructions.

5. The device of claim 1, wherein the instructions are further executable by the processor to perform operations comprising:
presenting a content management interface displaying a list of user-created AR content items;
receiving a user selection of an AR content item from the list;
displaying options to edit, delete, or share the selected AR content item; and
in response to receiving a user command to share the selected AR content item, generate a deep link associated with the AR content item, wherein the deep link is configured to launch an AR viewing application on an AR device and retrieve the associated AR content item from the server.

6. The device of claim 1, wherein the AR content item comprises:
three-dimensional (3D) spatial information defining a position and orientation of the AR content item within a real-world environment;
interactive elements that respond to user gestures or movements in the real-world environment;
depth information enabling the AR content item to interact with real-world objects, including occlusion and collision detection;
adaptive rendering instructions that adjust the appearance of the AR content item based on real-world lighting conditions; and
anchor points that allow the AR content item to be persistently placed in specific locations within the real-world environment, enabling relocalization of the AR content item across multiple viewing sessions.

7. The device of claim 1, wherein the instructions are further executable by the processor to:
present a location pinning interface within the content creation interface;
receive user input specifying a geographic location or area associated with the AR content item;
associate the specified geographic location or area with the AR content item as part of the metadata;
wherein the metadata enables the AR content item to be:
automatically suggested to users of AR devices when they are within a predetermined proximity to the specified geographic location or area; and
anchored to specific real-world coordinates or landmarks within the specified geographic location or area when viewed through an AR device.

8. A method comprising:
receiving, via a content creation interface of a content creation application, a user selection of a content theme from a plurality of available content themes;
presenting at least one content template associated with the selected content theme;
receiving user input corresponding to the at least one content template;
generating an AR content item based on the user input and the at least one content template;
creating metadata associated with the AR content item, wherein the metadata indicates (i) that the content item is AR content, (ii) the selected content theme, and (iii) the at least one content template used to generate the AR content item;
receiving a user command to publish the AR content item;
in response to receiving the user command to publish, communicating the AR content item and the associated metadata to a server for storage;
wherein the AR content item and the associated metadata are stored on the server in a manner that enables retrieval and presentation of the AR content item via an application executing on an AR device.

9. The method of claim 8, further comprising:
presenting a content creation interface comprising a plurality of input field groups, each group associated with a different aspect of the AR content item;
for each input field group:
displaying a set of input fields corresponding to the group;
receiving user input for each of the displayed input fields; and
presenting a user-selectable option to add a custom field to the group;
in response to user selection of the option to add a custom field:
displaying an interface for defining a new custom input field;
receiving user input defining the new custom input field;
adding the new custom input field to the current input field group;
after receiving input for all groups, generating the AR content item by populating the at least one content template with the user input received for each of the input fields in all groups.

10. The method of claim 8, further comprising:
presenting a media capture interface within the content creation interface;
in response to user selection of the media capture interface, invoking a camera application;
receiving user-captured media content via the camera application, wherein the user-captured media content comprises one or more photos or videos; and
incorporating the user-captured media content into the AR content item.

11. The method of claim 10, wherein:
the selected content theme is a food recipe theme;
a first input field group comprises fields for inputting ingredient information;
a second input field group comprises fields for inputting cooking instruction information;
the method further comprises:
presenting a media capture interface within the content creation interface for capturing images or videos of food preparation steps;
receiving user-captured media content via the media capture interface; and
incorporating the user-captured media content into the AR content item as visual aids for the cooking instructions.

12. The method of claim 8, further comprising:
presenting a content management interface displaying a list of user-created AR content items;
receiving a user selection of an AR content item from the list;
displaying options to edit, delete, or share the selected AR content item; and
in response to receiving a user command to share the selected AR content item, generating a deep link associated with the AR content item, wherein the deep link is configured to launch an AR viewing application on an AR device and retrieve the associated AR content item from the server.

13. The method of claim 8, wherein the AR content item comprises:
3D spatial information defining a position and orientation of the AR content item within a real-world environment;
interactive elements that respond to user gestures or movements in the real-world environment;
depth information enabling the AR content item to interact with real-world objects, including occlusion and collision detection;
adaptive rendering instructions that adjust the appearance of the AR content item based on real-world lighting conditions; and
anchor points that allow the AR content item to be persistently placed in specific locations within the real-world environment, enabling relocalization of the AR content item across multiple viewing sessions.

14. The method of claim 8, further comprising:
presenting a location pinning interface within the content creation interface;
receiving user input specifying a geographic location or area associated with the AR content item;
associating the specified geographic location or area with the AR content item as part of the metadata;
wherein the metadata enables the AR content item to be:
automatically suggested to users of AR devices when they are within a predetermined proximity to the specified geographic location or area; and
anchored to specific real-world coordinates or landmarks within the specified geographic location or area when viewed through an AR device.

15. A device comprising:
means for receiving, via a content creation interface of a content creation application, a user selection of a content theme from a plurality of available content themes;
means for presenting at least one content template associated with the selected content theme;
means for receiving user input corresponding to the at least one content template;
means for generating an AR content item based on the user input and the at least one content template;
means for creating metadata associated with the AR content item, wherein the metadata indicates (i) that the content item is AR content, (ii) the selected content theme, and (iii) the at least one content template used to generate the AR content item;
means for receiving a user command to publish the AR content item;
means for communicating, in response to receiving the user command to publish, the AR content item and the associated metadata to a server for storage;
wherein the AR content item and the associated metadata are stored on the server in a manner that enables retrieval and presentation of the AR content item via an application executing on an AR device.

16. The device of claim 15, further comprising:
means for presenting a content creation interface comprising a plurality of input field groups, each group associated with a different aspect of the AR content item;
for each input field group:
means for displaying a set of input fields corresponding to the group;
means for receiving user input for each of the displayed input fields; and
means for presenting a user-selectable option to add a custom field to the group;
means for displaying, in response to user selection of the option to add a custom field, an interface for defining a new custom input field;
means for receiving user input defining the new custom input field;
means for adding the new custom input field to the current input field group;
means for generating, after receiving input for all groups, the AR content item by populating the at least one content template with the user input received for each of the input fields in all groups.

17. The device of claim 15, further comprising:
means for presenting a media capture interface within the content creation interface;
means for invoking, in response to user selection of the media capture interface, a camera application on the device;
means for receiving user-captured media content via the camera application, wherein the user-captured media content comprises one or more photos or videos; and
means for incorporating the user-captured media content into the AR content item.

18. The device of claim 17, wherein:
the selected content theme is a food recipe theme;
a first input field group comprises fields for inputting ingredient information;
a second input field group comprises fields for inputting cooking instruction information;
the device further comprising:
means for presenting a media capture interface within the content creation interface for capturing images or videos of food preparation steps;
means for receiving user-captured media content via the media capture interface; and
means for incorporating the user-captured media content into the AR content item as visual aids for the cooking instructions.

19. The device of claim 15, further comprising:
means for presenting a content management interface displaying a list of user-created AR content items;
means for receiving a user selection of an AR content item from the list;
means for displaying options to edit, delete, or share the selected AR content item; and
means for generating, in response to receiving a user command to share the selected AR content item, a deep link associated with the AR content item, wherein the deep link is configured to launch an AR viewing application on an AR device and retrieve the associated AR content item from the server.

20. The device of claim 15, wherein the AR content item comprises:
means for defining 3D spatial information of a position and orientation of the AR content item within a real-world environment;
means for providing interactive elements that respond to user gestures or movements in the real-world environment;
means for enabling depth information for the AR content item to interact with real-world objects, including occlusion and collision detection;
means for adjusting the appearance of the AR content item based on real-world lighting conditions; and
means for allowing the AR content item to be persistently placed in specific locations within the real-world environment, enabling relocalization of the AR content item across multiple viewing sessions.
